(19) United States
(12) Patent Application Publication
(10) Pub. No.: US 2017/0252751 A1
(43) Pub. Date: Sep. 7, 2017

(54) Pressure Interference Wave Mill

(71) Applicant: Enagon Wave Technology, LLC, Newtown, CT (US)

(72) Inventors: Terry Ebels, Holland, MI (US); Christopher POLING, Newtown, CT (US)

(73) Assignee: Enagon Wave Technology, LLC, Newtown, CT (US)

(21) Appl. No.: 15/057,850

(22) Filed: Mar. 1, 2016

(51) Int. Cl. B02C 19/18; C22B 7/04

(52) U.S. Cl. CPC B02C 19/18; C22B 7/04; B02C 2019/183

(57) ABSTRACT

An apparatus for processing materials includes a chamber within which frequency turbine plates rotate relative to a circumferential wall having diametrically opposed portions which are asymmetric relative to each other. The circumferential wall with asymmetric arrangement in this manner promotes the generation of pressure differentials and interference wave phenomena when plates are rotated relative to such asymmetric arrangements, and thereby facilitates materials being processed through the associated apparatus. One suitable form of the apparatus comprises a pressure interference wave mill suitable for processing materials, such as slag.

### FIELD

This disclosure relates to apparatus and related methods for processing materials, and in particular, to apparatus and methods using pressure differentials and interference from associated waves.

### BACKGROUND

Current apparatus for processing materials, including reducing moisture in materials, reducing particle size, delaminating composites, and debonding agglomerates, suffer from various drawbacks and disadvantages. For example, typical milling and grinding operations accomplished by ball mills, pin mills, roller mills, hammer mills, and other types of grinding mills often require excessive energy consumption, processing times, or are otherwise inapplicable or inappropriate for certain materials or industries. In addition, materials subject to such milling processes often exit the mills 150° F. to 200° F. hotter than when inputted, sometimes requiring post-processing cooling periods, cooling vessels, or other accommodations which may add delay and expense to the associated process. Other devices making use of rotor plates attached to rotatable shafts have various shortfalls in throughput, processing efficiencies, or are otherwise inappropriate for certain industrial material streams.

In view of the foregoing, it would be desirable to address various shortcomings, limitations, or inefficiencies of the prior art.

### SUMMARY

This disclosure relates to apparatus and related methods for processing material. In one possible implementation, the apparatus comprises a pressure interference wave mill for processing material from industrial streams. The mill is characterized by rotating plates within a chamber configured so that at sufficient RPMs, zones of varying pressure, pressure differentials, shock waves, expansion fans, or other types of interference waves are formed, either singly or in combination. The chamber includes a circumferential wall, which is preferably asymmetric about its circumference, meaning that there are wall portions diametrically opposite each other which have dissimilar surface profiles. The shockwaves associated with one of the diametrically opposed portions may differ from those associated with the other of the diametrically opposed portions because of the difference in surface profile between the two diametrically opposed portions.

In other possible implementations, the circumferential wall may have an overall cross-section which is in the form of either an ellipse, an oval, or an egg-shaped cross-section referred to herein as “ovoid.” Wall portions of the circumferential wall may include inwardly and outwardly oriented surfaces relative to the overall cross-section of the circumferential wall. The diametrically opposed wall portions can include the internal housing surfaces themselves, amplifier pads, amplifier pockets, notches and internal wear liners.

In other possible implementations of this disclosure, besides slag, the apparatus is suitable for processing any number of materials, whether involving raw materials, waste materials, edible or inedible, toxic or landfill, virgin materials, spent materials, contaminated materials, mixtures of any or all of the foregoing, and so on. The circumferential wall in such implementations may have a horizontal cross-section characterized by a minor axis and a major axis longer than the minor axis.

In still other implementations, the circumferential wall includes multiple tabs disposed at variably spaced locations along the circumferential wall so as to form an asymmetrical arrangement of the tabs on the circumferential wall. The tabs may have differing tab profiles. The tab profiles further comprise surfaces which are angled relative to adjacent portions of the circumferential wall. There may be a second asymmetric arrangement of the tabs. Each of the asymmetric arrangements of the tabs may be located in a corresponding material processing zone. The first asymmetric arrangement of tabs may be different from the second asymmetric arrangement of tabs, or they be the same. When the arrangements are different from each other, the respective perimeters of the two material processing zones may differ from each other as to either their length, shape, or both. The asymmetric arrangements, either identical to each other or different from each other, produce a corresponding set of vibrational frequencies in their respective material processing zones when the disclosed apparatus is in operation.

Optionally, the first asymmetric arrangement of tabs is different from the second asymmetric arrangement of tabs. In this way, the respective perimeters of the two material processing zones differ from each other as to either their length, shape, or both. The asymmetric arrangements, either identical to each other or different from each other, produce a corresponding set of vibrational frequencies in their respective material processing zones when the apparatus according to this disclosure is in operation.

In one possible implementation, the apparatus includes between five and seven of the material processing zones, each of the zones having volumes ranging between 2850 cubic inches to 7775 cubic inches, and the apparatus can receive agglomerable materials and have a throughput of two to five tons per hour.

In still other possible implementations, the housing forming the chamber comprises multiple housing plates stacked in overlying relationship. The housing plates have interior edges which form the circumferential wall of the chamber. Boundary plates are interposed between groups of the multiple housing plates to define the material processing zones. In one possible variation, the housing plates are removably mounted relative to each other, so that the heights of corresponding material processing zones can be adjusted by removing or adding housing plates as appropriate.

Various materials may be processed, such as by inputting them as streams into the various implementations of the foregoing apparatus. In one associated method, the material is passed through a series of material processing zones within a chamber. The material is then exposed in the processing zones to pressure differentials and shockwaves generated by rotation of plates relative to at least one diametrically asymmetric arrangement of wall portions on a circumferential wall of the chamber.

In another possible method of operation, slag can be ground by feeding the slag through an inlet tube into a chamber, the chamber consisting of a series of plates rotating in spaced relation to each other at speeds ranging from about 3000 to 6000 RPMs. The chamber has a circumferential sidewall having an overall cross-section of either an ellipse, oval or two-dimensional ovoid. The slag is exposed to pressure differentials and interference waves generated by rotation of the plates relative to such circumferential wall.

### DESCRIPTION OF THE DRAWING

FIG. 1 is an isometric view of a possible implementation of the present disclosure, with portions cut away to further illustrate the implementation;

FIG. 2 is an isometric view of a possible implementation of the present disclosure, with partial cutaway segments;

FIG. 3 is a top sectional view of a possible implementation of the present disclosure;

FIG. 4 is an isometric sectional view of a possible implementation of the present disclosure;

FIG. 5 is an isometric view of a possible implementation of the present disclosure.

### DESCRIPTION

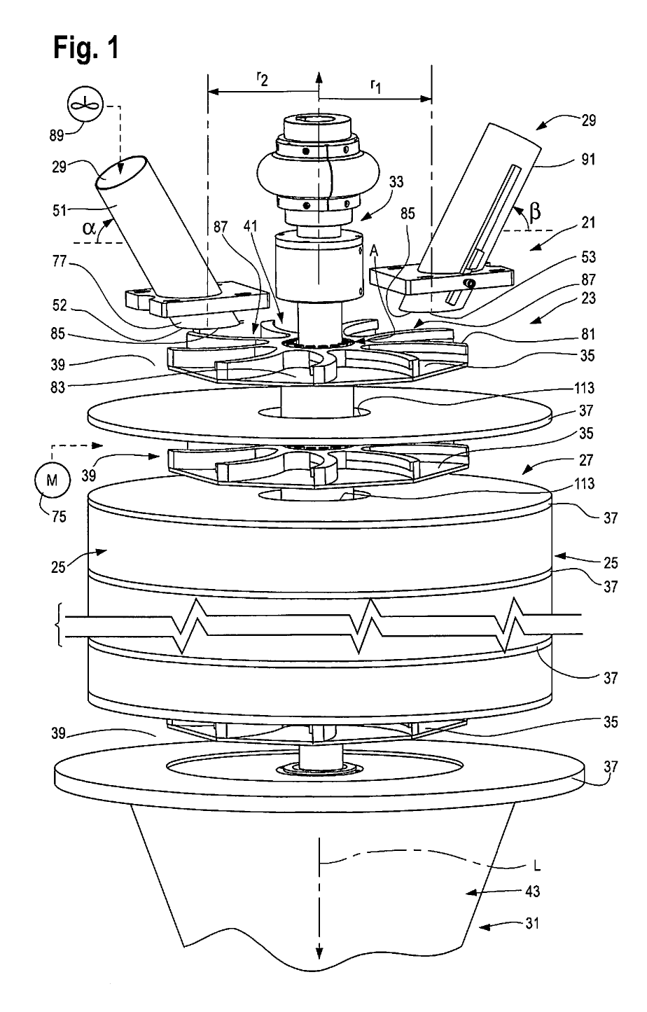

Certain implementations of an apparatus according to this disclosure are shown in FIGS. 1-5. Apparatus 21 is suitable for processing material in a wide variety of forms, consistencies, moisture content, size, and other physical characteristics. Apparatus 21 is adapted to expose materials to pressure differentials and interference waves, as disclosed herein, so as to achieve desired processing results. In the illustrated implementations, apparatus 21 includes a housing 25 defining a chamber 27. The chamber has an inlet 29 adapted for receiving the material to be processed into chamber 27, and an outlet 31 for discharging material from the chamber. A rotatable shaft 33 extends vertically within chamber 27.

In one possible implementation, apparatus 21 comprises a pressure interference wave mill 23. Pressure interference wave mill 23 may be adapted to process slag, whether blast furnace slag, steel slag, or any number of other slags generated by industrial waste processes, but it should be understood that pressure interference wave mill 23 is not limited to such materials and is suitable for numerous other applications and numerous other materials and associated processing methods.

A series of frequency turbine plates 35 and boundary plates 37 are arranged at vertically spaces locations along shaft 33. The boundary plates 37 and frequency turbine plates 35 extend generally transversely within chamber 27. The arrangement of frequency turbine plates 35 and boundary plates 37 define material processing zones 39 within chamber 27. In the illustrated orientations, there are shown a plurality of vertically stacked material processing zones, and each material processing zone is associated with one of the frequency turbine plates 35. An uppermost one of the material processing zones 39 is in communication with inlet 29, and the region within chamber 27 between such uppermost frequency turbine plate 35 and inlet 29 defines an inlet zone 41. In its illustrated orientations, a discharge zone 43 extends between the lowermost boundary plate 37 and outlet 31.

As seen from the foregoing, then, when apparatus 21 is in operation, material to be processed is received through inlet 29, passes through inlet zone 41, through material processing zones 39, through discharge zone 43, and is discharged through outlet 31.

Chamber 27 may include an upper surface 45 which has an outer circumference 47 located at the perimeter of housing 25. Upper surface 45 extends downwardly relative to inlet 29 from the outer circumference to form a convex portion 49. Inlet 29 may be in the form of one or more inlet tubes 51, inlet tubes 51 having corresponding openings 53 located in convex portion 49 of upper surface 45 of chamber 27.

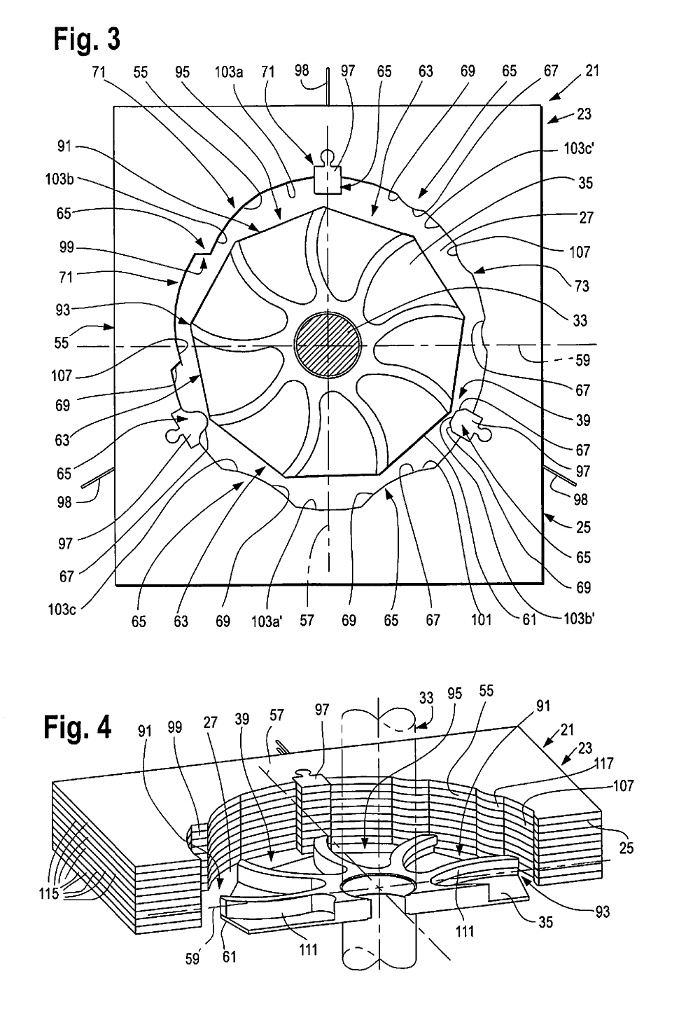

Chamber 27 includes a circumferential wall 55 (FIG. 3) having a cross section characterized by a minor axis 59 and a major axis 57. Major axis 57 is longer than minor axis 59. Frequency turbine plates 35 are mounted to shaft 33 and extend radially symmetrically therefrom, that is, in axial balance, to terminate in outer edges 61. Outer edges 61 may take a variety of forms, including linear portions as illustrated in FIG. 3, but can likewise be arcuate or assume other curved or non-linear profiles, so long as frequency turbine plates 35 are axially balanced about shaft 33. Because frequency turbine plates 35 are axially balanced and therefore have an effective average radius, whereas opposing portions of circumferential wall 55 vary in distance as a function of their location relative to major and minor axes 57, 59, the gaps 63 formed between outer edges 61 of frequency turbine plates 35 and opposing portions of circumferential wall 55 vary in size at different arcuate or radial locations along circumferential wall 55.

Circumferential wall 55 may be configured to include multiple tabs 65 connected or integral thereto. Tabs 65 have respective tab profiles 67 and, tab profiles may be selected so that at least two have differing profiles from each other. As seen in FIG. 3, tab profiles can include surfaces 69 angled relative to adjacent portions 71 of circumferential wall 55.

In the illustrated embodiment, tabs 65 are disposed at variably-spaced locations along circumferential wall 55, thereby forming an asymmetric arrangement 73 of tabs 65 on circumferential wall 55. Asymmetric arrangement 73 is disposed at a suitable location relative to boundary plates 37 so as to be in operative communication with at least one of material processing zones 39. In the illustrated embodiment, a single asymmetric arrangement extends vertically in relation to shaft 33 and circumferential wall 55 through two or more of the material processing zones 39.

Alternately, tabs 65 may be disposed along circumferential wall 55 so as to form at least two asymmetric arrangements 73 of tabs 65, each of the arrangements being in operative communication with corresponding ones of the material processing zones 39. The two asymmetric arrangements 73 can differ from each other in such implementation. The meaning of “operative communication” between asymmetric arrangements 73 and material processing zones 39 includes, without limitation, disposing all or a portion of tabs 65 so that they encounter air or material passing through the associated material processing zone or zones.

Shaft 33 of apparatus 21 is rotated by means of motor 75, suitably connected, and suitably configured to rotate frequency turbine plates 35 at sufficient RPMs to generate pressure differentials and associated variable compression zones within chamber 27. The resulting pressure differences formed within chamber 27 are many and varied. So, by way of example, not limitation, such pressure differences may vary over time, by location, as a function of RPM, or by size, magnitude, density of material(s) therein, and the like. The pressure differences or differentials (used interchangeably) may extend within or between material processing zones.

The provision of asymmetric arrangement 73 of tabs 65 promotes wave interference under Prandtl-Meyer or other physics, fluid dynamics or aerodynamic principles, which means in this disclosure that one or more waves, in any number of patterns or combinations, travel within chamber 27, encountering tabs 65 and other structures therein, as well as air, material and other waves therein. Such wave interference may be produced by waves of any kind or nature, whether referred to as pressure waves, standing waves, sound waves, shock waves, expansion fans, compression waves, shock waves, subsonic waves, vibration waves, and the like. The term “interference wave” used herein is intended to encompass any or all of these types of waves and associated wave phenomena generated by apparatus 21. Whatever their nature, these interference waves generated by apparatus 21 are associated with pressure differentials and variable compression zones. It will be appreciated that pressure differentials or differences include both positive and negative pressure differentials, and thus the term “compression zones,” “variable compression zones,” and the like, as used herein, include without limitation, both increased relative pressure, resulting in positive or expansive forces, as well as decreased relative pressure, resulting in negative or vacuum forces, and that directional forces are generated as well. Variable compression zones formed by apparatus 21 have been found to promote material processing.

For example, testing of apparatus 21 was performed using a single asymmetric arrangement 73, three material processing zones 39, and tabs arranged as shown in FIG. 3. When processing granulated blast furnace slag, 30 to 35 Kw hours per ton was used.

Particle size of the raw granulated blast furnace slag varied from 500 micron-2000 micron (0.5-2.0 mm) prior to being processed through apparatus 21 in the form of a pressure interference wave mill 23. After being processed, the sum particle size was reduced to less than 75 micron. The moisture content of the material was 6% prior to being processed. After being processed, the moisture content was less than 0.5%. Pressure interference wave mill 23 may require a total of 30-40 kwh/ton of material processed. The total energy used to reduce the particle size and eliminate the moisture as set out above was also significantly less than comparable systems. A ball mill grinding slag to similar particle sizes will require 68-72 kwh/ton of material processed.

A vertical roller mill grinding slag to a similar particle size may generally require 45-48 kwh/ton of material processed. Current vertical roller mills thus generally use about 50% more kilowatt hours per ton, requiring additional heat to be operated as well. Ball mills, when processing comparable granulated blast furnace slag, have an electrical efficiency from the foregoing ranges which make apparatus 21 about twice as efficient as ball mills under similar applications. In addition, unlike current ball mills and vertical roller mills, apparatus 21 generates much lower vibration levels for the equipment itself.

Furthermore, in order for slag to be processed in a ball mill, generally a substantial percent, such as approximately 75%, of all the raw feed must be dried and stored before it is ground. For slag to be processed in a vertical roller mill, an auxiliary heat source is generally used to dry the raw feed as it is being processed. The heat requirement to remove 6% moisture from one ton of granulated blast furnace slag using a vertical roller mill is approximately 191,000 btu per ton which, at a dryer efficiency of 70%, requires 256 cubic feet of natural gas per ton just for drying of the granulated blast furnace slag. The foregoing processes and associated costs of ball or vertical roller mills may be dispensed with when using pressure interference wave mill 23.

Other materials which have been processed include scrap wood, grape skins, coconut shell, corn husk, recycled papers all of which generated not only a particle size reduction but also generated a fiber which has applications into the cellulose wood fiber industry. Test results indicate particle sizes generated in the 50 micron range and a moisture content reduction of over 50%, including resulting moisture content in many applications ranging from 0% to 5%.

Coal combustion byproducts such as coal fly ash, coal mill fines, bottom ash, and synthetic gypsum when processed by apparatus 21, have produced results indicating a particle size reduction to the 40-75 micron range and a moisture content reduction of over 25%, including resulting moisture content in many applications being less than about 1%.

Apparatus 21 achieves desired processing goals and results in terms of one or more metrics, such as reducing particle size, reducing moisture, delaminating composites, debonding agglomerates, intermixing, and the like. In the case of granulated blast furnace slag, for example, chemically, the composition of granulated blast furnace (GBFS) slag makes it potentially useful as a cementitious material. When the material is ground to the ASTM standard of 80% passing a 45 micron screen, it becomes certified as Ground Granulated Blast Furnace Slag or GGBFS. GGBFS is well known to have cementitious qualities which are desirable in terms of improved strength, increased set time, improved workability and reduced cost. The particle size along with the chemical makeup of the slag determine the slag's activity index which can be determined through ASTM C989 testing. Slags processed to the ranges disclosed herein through pressure interference wave mill 23 may be generally classified as Grade 80 through Grade 120, dependent on the resulting strengths developed over 28 days.

Furthermore, coal combustion byproducts, such as fly ash or synthetic gypsum, are typically generated containing moisture ranges from 6%-22% when destined for a landfill, pond, or shipment as a conditioned material. Wet fly ash, whether freshly generated or recovered from an ash pond, is often difficult to use in concrete due to the variability of the moisture content, which is not easily controlled under ASTM standards. In order for fly ash to be used for DOT work, it must be dried and free flowing upon delivery to a ready-mix producer. In certain applications, it has been found that processing wet or ponded ash through pressure interference wave mill 23 may eliminate the moisture to the range of 0.2 to 0.5%, while reducing the particle size to advantageously increase the surface area available for use in desired applications. This moisture reduction generally permits the ash to be used in concrete as part of DOT or other suitable infrastructure applications. In addition, the particle size reduction aids in the flowability and performance of the concrete as a function of increase of surface areas.

Another coal combustion byproduct, synthetic gypsum, is typically shipped with moisture content ranging from 6-15%. The moisture causes the material to be very sticky, agglomerable and challenging to handle. It has been found that pressure interference wave mill 23 removes sufficient moisture to improve handling characteristics thereof, in some applications achieving the result of the product becoming substantially or completely dry and free flowing which allows it to be handled more easily, while reducing transportation costs.

Still other coal combustion byproducts, such as coal fly ash, as identified by ASTM specification C 618, are processable by pressure interference wave mill 23 to achieve certain technical results. This specification indicates that fly ash particles may be made up largely of silicon dioxide, aluminum dioxide and iron oxide. Such particles in fly ash may have different structures, may be solid composites or may be agglomerated materials. Other particles in fly ash are hollow and are called cenospheres. A cenosphere is generally a lightweight, inert, hollow sphere filled with inert air or gas, and cenospheres may comprise a bulk material useful in a variety of applications. Cenospheres may often be locked inside or bonded to particles referenced above or still other coal fly ash materials. Cenospheres have traditionally been reported to represent about 1-3% by weight of the total fly ash produced. Processing coal fly ash through pressure interference wave mill 23 has the result of recovering a higher percent of cenospheres from the fly ash, such as achieving a yield of 4%-5%. Accordingly, in such applications, the increase in cenosphere recovery may range from 70% to 500%.

Fibrous materials such as corn stalks, leaves, grass clippings, grape skins and wood pulp can be processed to yield the natural fibers without significantly destroying or otherwise compromising such fibers. These plant materials are composite materials, and include moisture, fibers, and other cellular structures. The moisture is eliminated as the particle sizes are reduced and the natural fibers are liberated on a steady basis through pressure interference wave mill 23. The resulting powder, in certain applications, is generated without the need for separate heating, drying, or grinding apparatus. The powder generated is effectively a wood flour and the cellulose fibers may have applications ranging from plastics to foodstuffs.

It has been found that, in certain applications, fibrous materials processed as above are useful in making textile fibers, and that, in such applications, such use of fibrous material reduces the need for other processes often associated with textile fiber-making, such as the viscose process, acid dissolution/washing, shredding, pulverizing, or ripening.

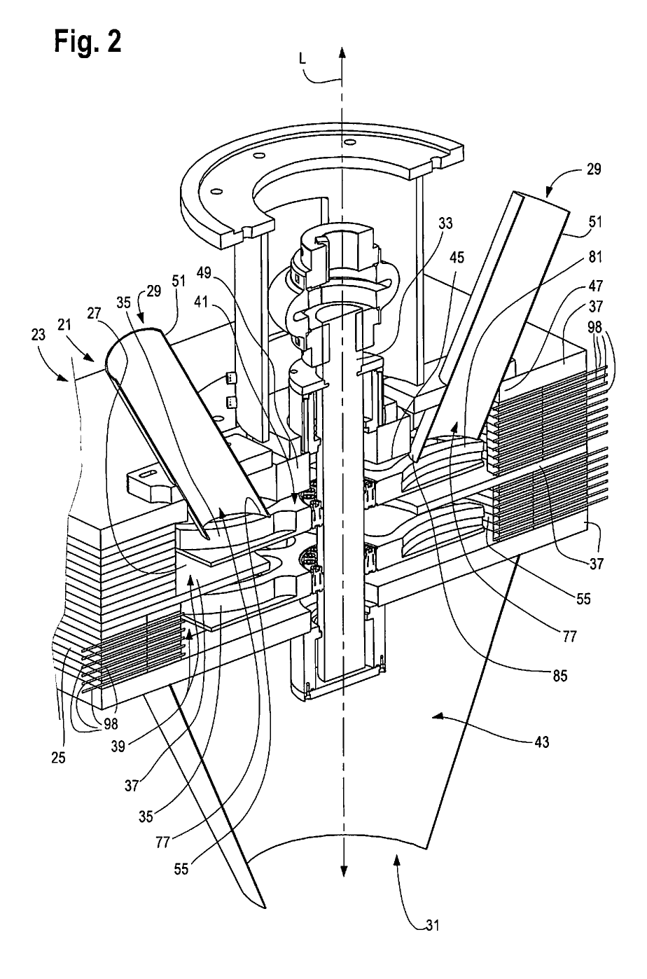

Referring now more particularly to FIG. 2, the two inlet tubes 51 have bottom ends 77 extending into inlet zone 41 at respective, entry angles α, β relative to the orientation of shaft 33, (shaft 33, as illustrated, has an orientation, which is a, 13 substantially vertical). Angles α, β of respective bottom ends 77 may be congruent to each other. Angles α, β may also be unequal, or tubes 51 may have different, respective orientations relative to either the vertical axis, relative to the plane of upper surface 45, or relative to each other. Accordingly, in certain implementations material exits inlet tubes 51 and enters inlet zone 41 at two different, respective entry angles.

Openings 53 are formed in bottom ends 77 and are spaced respective radial distances r₁, r₂ from longitudinal axis L of shaft 33. Radial distances r₁, r₂ of openings 53 may either be equal or substantially equal to each other, or may vary, such that entry point of material into inlet zone 41 from openings 53 may take place not only at differing radial distances from shaft 33, but also at differing radial distances in relation to the uppermost frequency turbine plate 81. Openings 53 may have any number of geometric configurations in cross-section. One suitable cross-section for openings 79 has been an oval, elliptical, or two-dimensional ovoid cross-section.

Although the illustrated inlet tubes 51 may have a substantially uniform diameter across their respective lengths, it is likewise contemplated that the diameters can vary across such lengths, in order to adjust, optimize, or otherwise affect material feeding or throughput of apparatus 21, especially with regard to inlet zone 41. So, for certain implementations, one or both inlet tubes 51 may be configured to have a restricted medial region of smaller diameter than adjacent regions along the length of inlet tubes 51, thereby forming a venturi tube (not shown). Such venturi arrangement, in certain applications, may accelerate or otherwise make more efficient the introduction of material through the associated inlet tube 51 into inlet zone 41.

In the illustrated embodiment, uppermost frequency plate 81 has a corresponding upper surface 83 defining part of inlet zone 41. Uppermost frequency plate 81 is rotatable at RPMs sufficient to form a rotating laminar airflow (indicated by reference A) above the surface 83 of uppermost frequency plate 81 in communication with inlet zone 41. Bottom ends 77 have corresponding lower edges 85 which are located within inlet zone 41 to be above, at, or near, laminar airflow A created above surface 83 of frequency plate 81, so that bottom ends 77 generally do not substantially disturb such airflow, and so that disturbance to such airflow from material exiting bottom ends 77 is likewise minimized to the extent the material characteristics permit, during operation of apparatus 21. It has been found that locating bottom ends 77 in such a manner, proximate laminar airflow A, without substantially disturbing it, promotes efficient entrainment of materials to be processed into chamber 27.

In furtherance of these advantages, one or both of inlet tubes 51 may be connected relative to chamber 27 so that the distance between bottom ends 77 and upper frequency plate 81 is selectively adjustable. Edges 85 may be shaped to include a plough, prow or other features minimizing disturbance of laminar airflow A. In this way, one or both of the inlet tubes 51 are movably mounted relative to uppermost frequency plate 81 and laminar airflow A. Inlet 29 may be pneumatically connected to a pressure fan 89 adapted to augment air flow into inlet zone 41 of apparatus 21.

Referring now to FIG. 3, housing 25 includes circumferential wall 55 defining chamber 27, such circumferential wall having a cross-section which is noncircular in form, and may be in the form of an ellipse, an oval, or an overall egg-shaped cross-section or ovoid, or any other forms having major and minor axes 57, 59. Outer edges 61 of frequency turbine plates 35 may have overall circumferences in the form of a polygon having more than six sides, a circle, or any other axially balanced shape, so that there is a corresponding circumference and an associated frequency turbine plate radius r_{f}. The juxtaposition of axially balanced frequency turbine plates 35 with a noncircular cross-section of circumferential wall 55 is believed to foster interference wave phenomena such as shockwaves, expansion fans, and other wave phenomena, as mentioned previously. These interference waves travel within chamber 27, bouncing off of structures located therein, including deflections, expansions, dissipation, and the like, which are promoted by tabs 65 and the asymmetric arrangement of such tabs 65 about circumferential wall 55, discussed in more detail below.

During operation of apparatus 21, within each material processing zone, the region above the frequency turbine plates is characterized overall as having lower pressure, whereas the region below the frequency turbine plates is characterized overall as having higher pressure These pressure differentials extend vertically (in the orientations illustrated) within and between material processing zones 39. These are not the only pressure differentials generated by the structures of apparatus 21. Furthermore, it should be understood that such overall higher and lower pressure zones may not be static or constant, but may vary, and though they may have an overall pressure differential between them, there will be additional localized pressure differentials forming, shifting, or dissolving during operations as a result of material flow and interference wave phenomena generated as discussed previously.

Furthermore, the juxtaposition of axially balanced frequency turbine plates 35 with a noncircular cross-section of circumferential wall 55 also form at least four compression zones 91 in material processing zones 39, two located at opposite ends of minor axis 59, referred to as zones 93, and two located at opposing ends of major axis 57, referred to as zones 95.

By virtue of the axially symmetric frequency plates 35 being placed within chambers 27 and its non-circular circumferential wall 55, compression zones 91 proximate to minor axis 57 have smaller volumes than compression zones 95 located proximate to major axis 59. During operation of apparatus 21, pressure differentials form generally in chamber 27, including in compression zones 91, and in or between the compression zones 93, 95. It will be appreciated that rotation of plates 35 within chamber 27 form pressure differentials in a variety of ways, including, without limitation, between material processing zones 39 as discussed above, by virtue of differing volumes of compression zones 91, by generation of shockwaves, expansion fans, and other interference waves as mentioned previously, by disruptions to air flow within chamber 27 caused by tabs 65 during operation of apparatus 21, through use of vortex fingers 98 as described subsequently, or as a result of still other features described herein.

Tabs 65 may assume any of a number of different forms, and, as seen in FIG. #3, are disposed so as to form portions of circumferential wall 55. Among the forms and configurations of tabs 65 are amplifier pads 97. Amplifier pads 97 may be removably secured to circumferential wall 55 and have corresponding profiles which include surfaces extending inwardly from the overall non-circular profile of circumferential wall 55. The inwardly extending surfaces of amplifier pads 97 may be linear or arcuate, with smooth curves or with angles, or any combinations thereof. Tabs 65 may likewise include amplifier pockets 99, which extend radially outwardly relative to the overall circumference of circumferential wall 55. Integral or removable internal wear liners 101 may also be disposed about the circumferential wall 55.

The arrangement of tabs 65 relative to circumferential wall 55 creates what will be termed an asymmetric arrangement 73 within chamber 27. In addition to the meanings of such terms to one of skill in the art, the terms “asymmetry” or “asymmetric” may have of a variety of meanings in the context of this disclosure. Thus, asymmetric arrangement 73 may include unequal or variable spacing of tabs 65 along circumference of circumferential wall 55, so that the circumferential distances between successive ones of tabs 65 are not equal. Asymmetric arrangement 75 may likewise include tab surfaces having radial distances from axis L of shaft 35 which vary, depending on the location of such surfaces on circumferential wall 55. Asymmetric arrangements 73 may also be asymmetric in the sense that, regardless of the presence or absence of tabs 65, wall portions 103a, 103b, and 103c differ from respective, diametrically opposed wall portions 103a′, 103b′, and 103c′. The differences between the opposing wall portions 103a, 103a′ may include differences in profile, shape, length, area, texture, charge, or any other physical characteristics. So, in the illustrated implementation, the differences between wall portions 103a, 103a′ may include wall portion 103a corresponding to one of the tabs 65, whereas diametrically opposed wall portion 103a′ is a part of the internal housing surface comprising the overall circumference of circumferential wall 55. As another example, diametrically opposed wall portions 103b, 103b′ may comprise a tab 65 opposed to an amplifier pocket 99. By way of still further example, opposing wall portions 103c, 103c′ may comprise two of the internal wear liners 101, having differences in cross section, shape, surface profile, surface area or the like.

Chamber 27 may include vortex fingers 98, which are illustrated as projections extending perpendicularly relative to shaft 33 through housing 25 and circumferential wall 55. Vortex fingers 98 may be located at any suitable radial location within chamber 27 and have portions located between outer edges 61 of frequency turbine plates 35 and circumferential wall 55.

Motor 75 may have a horsepower ranging from 7.5 to 400, and may be either an electric motor, an electric-vehicle motor, or a magnetic flux motor. Motor 75 is operatively connected to shaft 33 by suitable means, such as using direct drive, belt drive, a gear box, or similar transmission devices. The size and horsepower of motor 75 is selected depending on the anticipated application. Thus, for example, in the case of apparatus 21 comprising pressure interference wave mill 23, and such mill 23 likewise being configured to receive slag therein, motor 75 comprises, preferably, an electric motor ranging in horsepower from 75 hp to 150 hp, which has been found sufficient to rotate frequency turbine plates 35 at about 5500 RPMs. In general terms, motor 75 should have sufficient torque, horsepower, or other operational parameters to generate pressure differentials, as discussed above, sufficient to accomplish processing materials anticipated to be fed into apparatus 21. During operation and rotation of frequency turbine plates 35, it has been found that the one or more asymmetric arrangements 73 formed on circumferential wall 55 interact with frequency turbine plates 35 to produce corresponding sets of vibrational frequencies. There may be a single asymmetric arrangement 73 extending through or located in multiple material processing zones 39. There may be an identical asymmetric arrangement 73 for each of the material processing zones 39. There may be different asymmetric arrangement in one or more of the material processing zones 39. Tabs 65 may be varied in both form and arrangement such that multiple non-identical asymmetric arrangements 73 are formed. Arrangements 73 may also be different from each other in relation to surface characteristics, electric or magnetic charge, shape, tab arrangement, surface profiles, angles, perimeter length, and so on, as discussed previously. One or more of the asymmetric arrangements 73 may be disposed longitudinally along axis L and circumferentially along circumferential wall 55 independently of how such arrangement(s) relate to material processing zones 39.

Frequency turbine plates 35 may be mounted along shaft 33 so as to be one per material processing zone 39, as shown in FIGS. 1-4, but multiple frequency turbine plates 39 within a given material processing zone are likewise suitable, depending on any number of considerations, including the particular application, material, or desired results of processing. Referring to the drawings in general and FIG. 4 in particular, frequency turbine plates 35 may be provided with vanes 111 disposed on one or more planar surfaces of frequency turbine plates 35. Vanes 111 may be disposed in an outward radiating pattern, as illustrated, with a forward oriented arcuate shape in the sense that the tip of the vane, as illustrated, is forward of the medial portion of the vane. Vanes may likewise be backward oriented or orthogonal (not shown). The pattern of vanes 111 may be the same or substantially the same on two or more of the frequency plates disposed within chamber 27, or at least two different patterns of the vanes 111 may be used on at least two different ones of the frequency turbine plates 35. Still further variations in overall shape of frequency plates 35 or vanes 111 are, of course, possible. Vanes 111 may have surface features to promote material processing in general, or to achieve certain results or handle certain types of materials.

The vanes 111 and other characteristics of frequency turbine plates 35 are selected to create a surface area passing through the air and materials within chamber 25. Materials may encounter forces by direct or indirect contact with surfaces of frequency turbine plates 35 or with other material in chamber 27. Materials also experience forces from any number of interference waves or pressure differentials related to surrounding air or airflow of chamber 27. Rotation of frequency turbine plates 35 generally is sufficient to cause a turbulent airflow in at least certain regions of chamber 27. The surfaces of frequency turbine plates 35 generate and pass through turbulence. As such, uneven or turbulent airflow circulates within and through material processing zones 39, including apertures 113 formed in boundary plates 37, and gaps 63 between circumferential wall 55 and the frequency turbine plates 35. Pressure differences, shockwaves, other wave phenomena, air, and material may be deflected, dispersed, dissolved, reflected back or otherwise acted upon, unevenly, by virtue of the one or more asymmetric arrangements 73, variable compression zones, rotation of plates 35, and the other operational characteristics of chamber 27 discussed herein, creating patterns of forces on material to be processed arising from turbulence, pressure differences, and wave phenomena. The wave phenomena may be uneven in terms of any number of physical characteristics, whether pressure, sonic or vibratory in nature, including without limitation, angular orientations or locations about the circumference of circumferential wall 55, relative strength, volume, force, pressure, and so on.

Housing 25, in certain implementations, may be formed by using multiple housing plates 115 stacked in overlying relationship. Housing plates 115 have interior edges 117 which form, at least partially, circumferential wall 15 of chamber 27. Boundary plates 37 are interposed between groups or groupings of multiple housing plates 115. As such, the grouping of multiple housing plates and associated boundary plates define material processing zones 39. It will be appreciated that, if housing plates 115 are selectively removable relative to each other, the associated heights of material processing zones 39 can be varied, such that removing one or more of the housing plates from a group will reduce the corresponding height of the material processing zone and its overall volume, and, conversely, adding housing plates would increase such volume.

The use of the stacked housing plates 115, as opposed to casting or other more integrated solutions, has the advantage not only of adjusting the size and characteristics of material processing zones 39, but makes finishing of interior edges 117 of housing plates 115 more efficient. Interior edges 117 of housing plates 115 may wear down as materials impact circumferential wall 55 during processing, so hardening, plasma coating, and other processes are normally contemplated for the interior edges of housing plates 115. It will likewise be appreciated that the interior edges 117 of a given set of housing plates 115 need not define the same perimeters as adjacent plates. As such, adjacent housing plates 115 can be stepped or otherwise varied, allowing for still further asymmetric arrangements 73 to be produced to facilitate material processing, avoid wear, or avoid blowback of material toward inlet 29.

In certain implementations, housing plates 115 have thicknesses ranging from ⅛ inch to 1½ inches. In one suitable implementation, housing plates are ½ inch thick, and material processing zones 39 include between 12 and 22 of such housing plates. Frequency turbine plates 35, in some implementations, have bases (from which vanes 111 extend) ranging in thickness from ⅛ inch to 4½ inches, have diameters ranging from 22 inches to 30 inches, and include from four to twelve of the vanes 111.

In one implementation, the differences in length between the major and minor axes of chamber 27 may be as large as 2″. Tabs 65 may include internal wear liners having a curvilinear profile of between 2 inches and 14 inches in length. Amplifier pads 97 may have polygonal profiles having profiles of 2.25″ in length, extending 1″ to 3″ internally from overall circumference of circumferential wall 55.

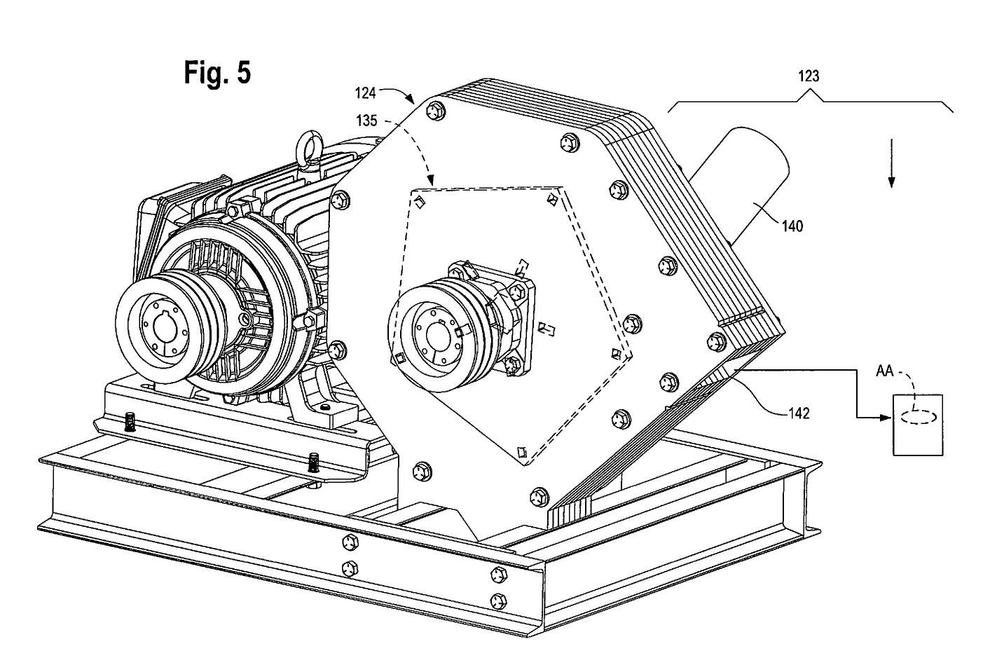

Referring now to FIG. 5, a pressure interference wave mill 123 is provided, with an initial frequency turbine unit 124 having an initial turbine plate 135 located in a corresponding initial material processing zone 139. Turbine unit 124 includes an initial feeder 140 adapted to receive agglomerable materials to be processed, and in communication with initial turbine plate 135. Initial frequency turbine unit 124 is powered by suitable means and otherwise configured to perform an initial size reduction of the agglomerable materials. Unit 124 has an outlet 142 located in inlet zone 129 of pressure interference wave mill 123, and in pneumatic communication with a laminar airflow AA therein.

Referring to FIGS. 1-4, chamber 27 of apparatus 21 may be connected electrically so that an electric potential is formed on one or more portions of circumferential wall 55, or alternating current or polarity is applied to portions of chamber 27. In this case, electrodes are connected to vortex fingers 98 and a suitable power source outside chamber 25. Sufficient electric potential is provided to impart charge to material in operative proximity to the one or more of the electrically charged tabs 65, which are provided with such electric potential. Suitable electric potential has been found to range between 25 my and 90 mv. Induced charges can be varied to affect the hertz, emissivity, electric and polar/nonpolar aspects of the materials being processed. Charges have been found to weaken bonds or agglomeration of certain materials and thus promote processing by apparatus 21.

Tabs 65, whether in the form of integral internal housing surfaces, removable pads, wear liners, and the like, may be configured to carry a magnetic charge, such portions of circumferential wall 55 being located in corresponding material processing zones, and the electromagnetic charge being sufficient to affect particles and materials passing through the processing zone. Materials so affected will become magnetically aligned along their polar axis. The interference waves generated by the housing will seek to disrupt this alignment resulting in increased particle size reductions as the two induced forces interact with the particle when applied to tabs 65.

Having set out in detail the structures and features of various implementations of the apparatus of this disclosure, various methods of operation of apparatus 21 are readily apparent. Material is fed through inlet 29 for processing and inlet 29, as illustrated, has multiple inlet tubes 51, forming associated angles relative to longitudinal axis L and the upper surface of chamber 27. Material to be processed enters inlet zone 41. In certain implementations, inlet tubes 51 are adapted so that material exiting their bottoms ends 77 are introduced within or proximal to laminar flow A caused by rotation of uppermost frequency turbine plate 81. In addition, it is also possible to configure upper surface 45 of inlet zone 41 so that it is convex, which, again, can benefit entrainment or feeding of material into inlet zone 41.

Once material enters chamber 27, starting with inlet zone 41, it is acted upon by the various features within chamber 27 discussed above, namely the surfaces of frequency turbine plates 35, rotating relative to the surrounding housing 25, including its circumferential wall 55, as well as the various features of circumferential wall 55 discussed previously, including tabs 65 and gaps 63 formed between outer edges of frequency turbine plates 35 and opposing portions of circumferential wall 55. In the illustrated embodiment, material passes between a plurality of the material processing zones 39, which are formed between boundary plates 37. Apertures 113 in boundary plates 37 permit material being processed to pass between material processing zones.

Suitable rotation of frequency turbine plates 35 relative to circumferential wall 55 generates not only pressure differentials, but also interference waves. Circumferential wall 55 includes at least one diametrically asymmetric arrangement of wall portions 103, which has been found to promote generation of such wave phenomena. The material processing proceeds from an upper position where materials are fed, downwardly with the assistance of gravity, ultimately exiting apparatus 21 through discharge zone 43 and its associated outlet 31.

In one possible implementation, laminar air flow proximate to the upper surface of uppermost frequency plate 81 is formed by rotating such frequency turbine plate between about 3000 to about 6000 RPMs. Depending on the application and desired processing results, multiple asymmetric arrangements can be provided within chamber 27 and at least two of such arrangements may be different from each other. As such, materials being processed are exposed to a first set of pressure differentials and shockwaves associated with one of such asymmetric arrangements and a second set of pressure differentials associated with a second asymmetric arrangement. In further methods, it may be desirable to expose material being processed to electric potential when it is passed through chamber 27, or through magnetic potential (or both).

In a related method, apparatus 21 can be customized or modified by using housing plates having associated thicknesses, and grouping such housing plates between respective boundary plates, thereby selecting or varying the volume of material processing zones within apparatus 21.

Apparatus 21, among other applications, can be used in grinding slag in any number of forms, whether emanating from blast furnaces, steel making, or other industrial processes. Such a method would involve feeding the slag through inlet 29 into chamber 27, exposing the slag to pressure differentials, such as those generated by rotating the frequency turbine plates 35 at speeds ranging between about 3000 RPMs to about 6000 RPMs. In one method, the slag is exposed to a chamber whose circumferential wall has an overall cross section selected from the group consisting of an ellipse, oval or ovoid. Slag and other materials may be processed to achieve any number of desirable results, including without limitation, reducing moisture, reducing particle size, separating, purifying, or mixing materials, delaminating composites, debonding agglomerates, pulverizing, screening, and other types of size alterations, any of the foregoing with or without impact grinding.

Besides slag and granulated blast furnace slag, apparatus 21 may be suitably configured to process any number of other cementitious materials, such as pozzolan, pumice, coal fly ash, as well as cement kiln raw materials, such as Waelz kiln slag (IRM), coal fly ash, pumice, calcite, limestone, bauxite and sand.

Other suitable applications for apparatus 21 include food stuffs, such as blueberries, orange, peel, coconut, bananas, peanuts, olives, grapes, grape skins, olive pits, olive peel, corn, corn husks, and the like. Still other configurations of apparatus 21 may process newspapers, municipal waste, leaves, waste oil, metallic aluminum, coal, coal fines, plastic bottle caps, wood, scrap lumber, scrap roofing materials, and egg shells.

Apparatus 21 may likewise be adapted to process or blend several, different raw materials within chamber 27 simultaneously. Given the moisture reduction and drying effect of operation of apparatus 21 on most materials, the resulting processing of different raw materials may result in a homogeneous powder, potentially with less moisture than the original raw materials introduced.

Apparatus 21 may be adapted so that chamber 27 is able to accommodate inert gases in a sealed manner, in addition to air or as a substitute therefore. Thus, for example, nitrogen may be fed into chamber 27 for purposes of reducing the risk of combustion of materials subjected to processing within chamber 27, such as tire fines, and coal.

Although various implementations, variations, and associated methods, have been disclosed, it will be appreciated that still further alternatives and implementations are within the spirit and scope of the present disclosure. For example, the size and number of material processing zones can be reduced or increased, depending on the particular applications and results desired. Furthermore, although the orientation of the device is shown to process materials with the assistance of gravity, from an upper end relative to gravity down to a lower discharge end, reverse orientations, moving materials contrary to gravity, are likewise contemplated, including those which impel or otherwise urge material in directions against gravity, whether vertically, upwardly or at any number of angular orientations.

Furthermore, while apparatus 21 is shown as making use of a single longitudinal axis L about which shaft 33 spins, multiple axes or multiple shafts may be provided, either parallel, at angles, or orthogonally, and such axes or shafts may be associated with one or more chambers, or material processing zones, inlets, or outlets. Still further variations, implementations, and modifications are contemplated.

Having described implementations of apparatus 21 and associated methods, various advantages are apparent. Materials may be processed with appropriate through put for a number of industrial processes and streams. Accordingly, a wide variety of materials can have their particle sizes reduced to desire ranges, and materials can be separated, debonded, and otherwise altered efficiently. Certain materials processed in accordance with the apparatus and methods herein generally do not become heated by more than about 5° F., so no cooling steps or cooling apparatus is required. The use of typical milling or grinding operations, including those performed by prior-art ball mills, pin mills, roller mills, hammer mills and other types of grinding mills, may be reduced or eliminated, thereby offering advantages as to reduced time and cost savings. The apparatus 21 disclosed herein, furthermore, may be scaled up or scaled down, depending on the user requirements.

Accordingly, this disclosure is not limited to the precise details, methodologies, or constructions set forth herein, nor to the illustrated implementations or variations thereof described herein, and thus still further variations and implementations are within the spirit and scope of this disclosure.

What is claimed is:

1. An apparatus for processing a stream of material, comprising:
a housing defining a chamber, the chamber having an inlet for receiving the material into the chamber, and an outlet for discharging material from the chamber;
a rotatable shaft extending vertically within the chamber;
a series of frequency turbine plates and boundary plates arranged at vertically spaced locations along the shaft and extending transversely within the chamber to define multiple, material processing zones within the chamber, the frequency turbine plates and boundary plates configured to permit the material to pass between the zones during operation, whereby the material to be processed is received through the inlet, passes through the material processing zones, and is discharged through the outlet;
wherein the chamber includes a circumferential wall having a horizontal cross-section characterized by a minor axis and a major axis longer than the minor axis;
wherein the frequency turbine plates are mounted to the shaft and extend therefrom in axial balance to terminate in outer edges;
wherein the circumferential wall includes multiple tabs disposed at variably-spaced locations along the circumferential wall to form at least one asymmetric arrangement of the tabs on the circumferential wall;
wherein the tabs have respective tab profiles, the tab profiles of at least two of the tabs differing from each other;
wherein the tab profiles comprise surfaces angled relative to adjacent portions of the circumferential wall;
wherein the asymmetric arrangement of the tabs is located on the circumferential wall relative to the boundary plates to be in operative communication with at least one of the material processing zones; and
the apparatus further comprising a motor operatively connected to the shaft and adapted to rotate the frequency turbine plates at sufficient RPMs to form variable compression zones within the chamber.

2. The apparatus of claim 1, wherein the apparatus comprises a pressure interference wave mill configured to receive slag therein, the pressure interference wave mill adapted to rotate the frequency turbine plates at about 5500 RPMs and further adapted to generate interference waves in the material processing zones.

3. The apparatus of claim 1, wherein the circumferential wall has a cross section selected from the group consisting of an ellipse, an oval, or an egg-shaped cross-section.

4. The apparatus of claim 1, wherein the tabs are selected from the group consisting of internal housing surfaces, amplifier pads, amplifies pockets, and internal wear liners.

5. The apparatus of claim 1, wherein the tabs are removably secured to the circumferential wall.

6. The apparatus of claim 1, wherein the tabs are integral to the circumferential wall.

7. The apparatus of claim 1, further comprising vortex fingers extending transversely relative to the shaft and having portions terminating between the outer edge of at least one of the frequency turbine plates and the circumferential wall.

8. The apparatus of claim 1, wherein the motor has a horsepower ranging from 7.5 to 400 and is selected from the group consisting of an electric motor, an electric-vehicle motor and a magnetic flux motor.

9. The apparatus of claim 8, wherein the motor is operatively connected to the shaft by means selected from the group consisting of a direct drive, belt drive and a gear box.

10. The apparatus of claim 1, wherein the chamber comprises a convex upper surface, and wherein the inlet comprises at least two inlet tubes having corresponding openings in the convex upper surface.

11. The apparatus of claim 10, wherein the openings comprise bottom ends of the inlet tubes, the bottom ends of the inlet tubes extending into the chamber at respective, entry angles relative to vertical.

12. The apparatus of claim 11, wherein the angles of the bottom ends of the inlet tubes are dissimilar, so that material from one of the inlet tubes enters the chamber at an entry angle different from the entry angle of the material entering from another of the inlet tubes.

13. The apparatus of claim 10, wherein inlet tubes have corresponding openings in the upper surface of the housing located differing radial distances from the shaft of the apparatus.

14. The apparatus of claim 1, wherein the inlet comprises at least one inlet tube having a uniform, oval cross-section and extending to a lower edge disposed within the inlet zone.

15. The apparatus of claim 1, wherein the inlet comprises a venturi tube having a restricted, medial region of smaller diameter than adjacent regions of the tube, the venturi tube adapted to accelerate introduction of the material into the inlet zone.

16. The apparatus of claim 1, wherein the inlet is in communication with an inlet zone defined within the chamber, and an uppermost one of the frequency plates is disposed adjacent to the inlet zone, and wherein the apparatus is adapted to develop a laminar airflow within the inlet zone upon rotation of the uppermost frequency plate, and wherein the inlet comprises at least one inlet tube having a bottom edge in the inlet zone, the inlet tube being moveably mounted relative to the uppermost frequency turbine plate to adjust the location of the bottom edge of the tube relative to the laminar airflow.

17. The apparatus of claim 1, wherein the apparatus comprises a pressure interference wave mill, the apparatus including between 5 and 7 of the material process zones, each of the zones having volumes ranging between 2850 cubic inches to 7,775 cubic inches to receive agglomerable materials therein at a rate of 2 to 5 tons per hour.

18. The apparatus of claim 17, wherein each of the material processing zones has a perimeter surface comprising a corresponding one of the asymmetric arrangements and wherein respective ones of the material processing zones have a corresponding set of vibrational frequencies.

19. The apparatus of claim 18, wherein the respective perimeter surfaces of the material processing zones are identical as to length and shape.

20. The apparatus of claim 18, wherein the respective perimeters of the material processing zones are non-identical as to at least one of length and shape.

21. The apparatus of claim 1, wherein the frequency turbine plates are mounted alternately with the boundary plates to vertically stack the material processing zones, each of the processing zones having a corresponding one of the frequency turbine plates disposed therein.

22. The apparatus of claim 1, wherein the frequency turbine plates have respective patterns of vanes defined thereon.

23. The apparatus of claim 22, wherein each of the zones has at least one of the frequency turbine plates, and each of the turbine plates has substantially the same pattern of vanes.

24. The apparatus of claim 22, wherein at least two of the turbine plates are configured to differ from each other in terms of at least one of the pattern of vanes disposed thereon and the shape of the outer edge.

25. The apparatus of claim 22, wherein the patterns of vanes are selected from the group consisting of forward-oriented vanes, backward-oriented vanes, and orthogonal vanes.

26. The apparatus of claim 1, further comprising an initial frequency turbine unit having an initial turbine plate mounted perpendicularly to the shaft of the apparatus; wherein the initial plate is in communication with an initial feeder adapted to receive agglomerable materials to be processed;
wherein the unit is adapted to perform in initial size reduction of the agglomerable materials, the initial turbine unit having an outlet located in the inlet zone in communication with the laminar flow.

27. The apparatus of claim 1, further comprising a pressure fan pneumatically connected to the inlet and adapted to augment airflow into the apparatus from the inlet.

28. The apparatus of claim 1, wherein the housing comprises multiple housing plates stacked in overlying relationship, the housing plates having interior edges forming the circumferential wall of the chamber, the boundary plates interposed between groups of the multiple housing plates to define the material processing zones.

29. The apparatus of claim 23, wherein the housing plates are removably mounted relative to each other, wherein the material processing zones have associated heights, the heights being adjustable by one of the following operations: removing one of the housing plates from one of the groups of housing plates and adding one of the housing plates to one of the groups of housing plates.

30. The apparatus of claim 1, wherein the chamber is connected to an electric potential and includes at least one conductive path to the circumferential wall disposed in at least one of the material processing zones, the electric potential being sufficient to impart charge to portions of the material in the processing zone to increase material separation;

31. The apparatus of claim 1, wherein the chamber includes portions carrying an electromagnetic potential relative to the air flows within the chamber, the electromagnetic potential being sufficient to impart electromagnetic charge to at least a portion of the material in the processing zone associated with the circumferential wall having the electromagnetic potential.

32. A pressure interference wave mill for processing material from industrial streams, such as slag, the mill comprising:
a housing defining a chamber adapted to process about two to about five tons of slag per hour during operation, the chamber having an inlet adapted to receive the slag into the chamber, and an outlet for discharging the slag from the chamber;
a rotatable shaft extending vertically within the chamber;
a series of frequency turbine plates and boundary plates arranged at vertically spaced locations along the shaft and extending transversely within the chamber to define multiple, material processing zones within the chamber, an inlet zone in communication with the inlet and a discharge zone in communication with the outlet, the frequency turbine plates and boundary plates configured to permit the material to pass between the zones during operation, whereby the material to be processed is received through the inlet, passes through the inlet zone, through the material processing zones, through the discharge zone, and is discharged through the outlet;
wherein the chamber includes a circumferential wall having at least one pair of wall portions diametrically opposed to each other and in operative communication with at least one of the material processing zones, the diametrically opposed wall portions having dissimilar surface profiles to form a diametrically asymmetric arrangement on the circumferential wall; and
the apparatus further comprising a motor operatively connected to the shaft to rotate the frequency turbine plates at RPMs sufficient to form interference waves.

33. The mill of claim 32, wherein the circumferential wall has an overall cross-section selected from the group consisting of an ellipse, an oval, and an egg-shaped cross-section, and is characterized by a minor axis and a major axis longer than the minor axis, wherein at least one of the wall portions has a surface extending inwardly or outwardly from the overall cross-section.

34. The mill of claim 33, wherein the diametrically opposed portions are selected from the group consisting of internal housing surfaces, amplifier pads, amplifier pockets, notches, and internal wear liners.

35. The mill of claim 33, wherein one of the diametrically opposed wall portions of the pair has a surface extending inwardly or outwardly from the cross-section, and the other of the diametrically opposed wall portions of the pair has a surface coincident with a corresponding portion of the overall cross-section.

36. The mill of claim 32, wherein the frequency turbine plates are rotatable at RPMs sufficient to form a laminar airflow above an uppermost one of the frequency turbine plates in the inlet zone; and wherein the chamber has an upper surface opposing the inlet zone, the upper surface having an outer circumference, the upper surface extending downwardly from the outer circumference to form a convex portion, the convex portion positioned proximate to the laminar airflow, wherein the inlet has a lower edge defined in the convex portion.

37. The mill of claim 32, wherein the chamber includes portions electrically connected to an electric potential and includes at least one conductive path to the circumferential wall disposed in at least one of the material processing zones, the electric potential being sufficient to impart charge to portions of the material in the processing zone to increase material separation

38. The mill of claim 32, further comprising at least a second asymmetric arrangement located on the circumferential wall relative to the boundary plates to be in operative communication with another one of the material processing zones.

39. The mill of claim 32, wherein the housing comprises multiple housing plates stacked in overlying relationship, the housing plates having interior edges forming the circumferential wall of the chamber, the boundary plates interposed between groups of the multiple housing plates to define the material processing zones.

40. The mill of claim 39, wherein the housing plates are removably mounted relative to each other, wherein the material processing zones have associated heights, the heights being adjustable by one of the following operations: removing one of the housing plates from one of the groups of housing plates and adding one of the housing plates to one of the groups of housing plates.

41. A method of processing materials, comprising:
passing the material through a series of processing zones having a diametrically asymmetric circumferential wall;
rotating radially balanced frequency turbine plates relative to the asymmetric circumferential wall at sufficient RPMs; and
exposing the materials to pressure differentials and interference waves to generate processed materials.

42. The method of claim 41, further comprising the steps of:
forming a laminar airflow zone within an inlet zone of the chamber by rotating the plates in a range between about 3000 to about 6000 RPMs; and
feeding the material into the chamber through an opening located within the laminar airflow zone.

43. The method of claim 42, exposing the material to pressure differentials and interference waves comprises exposing the material to a first set of the interference waves associated with a first diametrically asymmetric arrangement of one of the material processing zones, and thereafter exposing the material to a second set of interference waves associated with a second diametrically asymmetric arrangement of another one of the material processing zones.

44. The method of claim 41, further comprising the step of exposing the material to electric potential when it is passed through the chamber.

45. The method of claim 41, further comprising the steps of forming the processing zones with respective heights by stacking a selected number of housing plates having associated thicknesses between boundary plates.

46. A method of grinding slag, comprising:
feeding the slag through an inlet tube into a chamber containing a series of plates rotating in spaced relation to each other at speeds ranging between about 3000 to about 6000 RPMs, wherein the chamber has a circumferential wall having an overall cross-section selected from the group consisting of an ellipse, oval, or ovoid; and
exposing the slag to pressure differentials and interference waves.
